(19) United States
(12) Patent Application Publication
(10) Pub. No.: US 2015/0378849 A1
(43) Pub. Date: Dec. 31, 2015

(54) METHOD AND DEVICE FOR BACKING UP, RESTORING A VIRTUAL MACHINE

(71) Applicant: International Business Machines Corporation, Armonk, NY (US)

(72) Inventors: Xiao Xi Liu, Beijing (CN); Jian Qiu, Beijing (CN); Yuan Wang, Beijing (CN); Jian Ming Zhang, Beijing (CN)

(21) Appl. No.: 14/737,540

(22) Filed: Jun. 12, 2015

(30) Foreign Application Priority Data
Jun. 30, 2014 (CN) 201410305811.2

(51) Int. Cl. G06F 11/14

(52) U.S. Cl. CPC G06F 11/1484; G06F 11/1451; G06F 11/1464; G06F 2201/84

(57) ABSTRACT

A method for backing up or restoring a virtual machine is provided. The backup method includes creating a virtual machine having a first and a second union file system directory. The first directory read only stores a virtual machine base operating system file. The second directory is readable and writable and stores modifications to the base operating system file, and new files generated during running of the virtual machine. The virtual machine preferentially reads and writes the second directory. When a request to back up the virtual machine is received, the data in the second directory is backed up. The restore method includes preparing a virtual machine for restoring data. When a request to restore the virtual machine is received, the backup data of the second directory is obtained and restored to the second directory of the prepared virtual machine.

### BACKGROUND

The present invention relates to virtual machine (VM) backup and restore, and more specifically, to a method and device for backing up, restoring a virtual machine more flexibly.

A virtual machine may fail due to various reasons while running. This may be caused by failure of the virtual machine itself, or software failure resulting from a hypervisor, a middleware or the like. To avoid loss of user data, there is a need to provide a technology for backing up and restoring a virtual machine.

There are various options for backing up and restoring a virtual machine. For example, a VM may be backed up at hypervisor level, which requires a hypervisor specific backup solution. Or, the Infrastructure as a Service (IaaS) provider may provide VM backup and restore capability but it is entirely controlled by IaaS provider. A third party independent software vendor (ISV) may not provide such backup and restore service Development and application of virtual machines may be restricted based on backup and restore ability. Furthermore it is difficult to determine the content that needs to be backed up.

It can be seen from the above that, there is a need to provide a technical solution for conveniently backing up and restoring a virtual machine.

### SUMMARY

According to a first aspect of the present invention, there is provided a method for backing up a virtual machine, comprising: creating a virtual machine comprising a first directory and a second directory managed by a union file system, wherein, the first directory is configured to be read only and used for storing a virtual machine base operating system file, and the second directory is configured to be readable and writable and used for storing change generated during running of the virtual machine; running the virtual machine, the virtual machine preferentially reads and writes the second directory during running; backing up the virtual machine according to data of the second directory in response to receiving a request for backing up the virtual machine.

According to a second aspect of the present invention, there is provided a method for restoring a virtual machine, comprising: preparing a virtual machine for restoring data, the prepared virtual machine comprises a first directory and a second directory managed by a union file system, wherein, the first directory is configured to be read only and used for storing a virtual machine base operating system file, and the second directory is configured to be readable and writable and used for storing changed data generated during running of the virtual machine; obtaining corresponding backup data of the second directory in response to a restore operation; restoring the obtained backup data to the second directory of the newly created virtual machine.

According to a third aspect of the present invention, there is provided a device for backing up a virtual machine, comprising: a creation module configured to create a virtual machine comprising a first directory and a second directory managed by a union file system, wherein, the first directory is configured to be read only and used for storing a virtual machine base operating system file, and the second directory is configured to be readable and writable and used for storing change generated during running of the virtual machine; a running module configured to run the virtual machine, the virtual machine preferentially reads and writes the second directory during running; a backup module configured to back up the virtual machine according to data of the second directory in response to receiving a request for backing up the virtual machine.

According to a fourth aspect of the present invention, there is provided a device for restoring a virtual machine, comprising: a preparing module configured to prepare a virtual machine for restoring data, the prepared virtual machine comprises a first directory and a second directory managed by a union file system, wherein, the first directory is configured to be read only and used for storing a virtual machine base operating system file, and the second directory is configured to be readable and writable and used for storing change generated during running of the virtual machine; an obtaining module configured to obtain corresponding backup data of the second directory in response to receiving a restore request; a restoring module configured to restore the obtained backup data to the second directory of the newly created virtual machine.

With the method and device of the present invention, a general technical solution for backing up and restoring a virtual machine can be provided.

### BRIEF DESCRIPTION OF THE SEVERAL VIEWS OF THE DRAWINGS

Through the more detailed description of some embodiments of the present disclosure in the accompanying drawings, the above and other objects, features and advantages of the present disclosure will become more apparent, wherein the same reference generally refers to the same components in the embodiments of the present disclosure.

FIG. 1 shows a block diagram of an exemplary computer system/server 12 which is applicable to implement the embodiments of the present invention.

FIG. 2 shows a flowchart of a method for backing up a virtual machine according to an embodiment of the present invention.

FIG. 3 shows a diagram of backing up a virtual machine according to a more specific embodiment of the present invention.

FIG. 4 shows a flowchart of a method for restoring a virtual machine according to an embodiment of the present invention.

FIG. 5 shows a diagram of restoring a virtual machine according to a more specific embodiment of the present invention.

FIG. 6 shows a diagram of a device for backing up a virtual machine according to an embodiment of the present invention.

FIG. 7 shows a diagram of a device for restoring a virtual machine according to an embodiment of the present invention.

### DETAILED DESCRIPTION

Some preferable embodiments will be described in more detail with reference to the accompanying drawings, in which the preferable embodiments of the present disclosure have been illustrated. However, the present disclosure can be implemented in various manners, and thus should not be construed to be limited to the embodiments disclosed herein. On the contrary, those embodiments are provided for the understanding of the present disclosure, and to convey the scope of the present disclosure to those skilled in the art.

As will be appreciated by one skilled in the art, the present invention may be embodied as a system, method or computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable storage medium is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

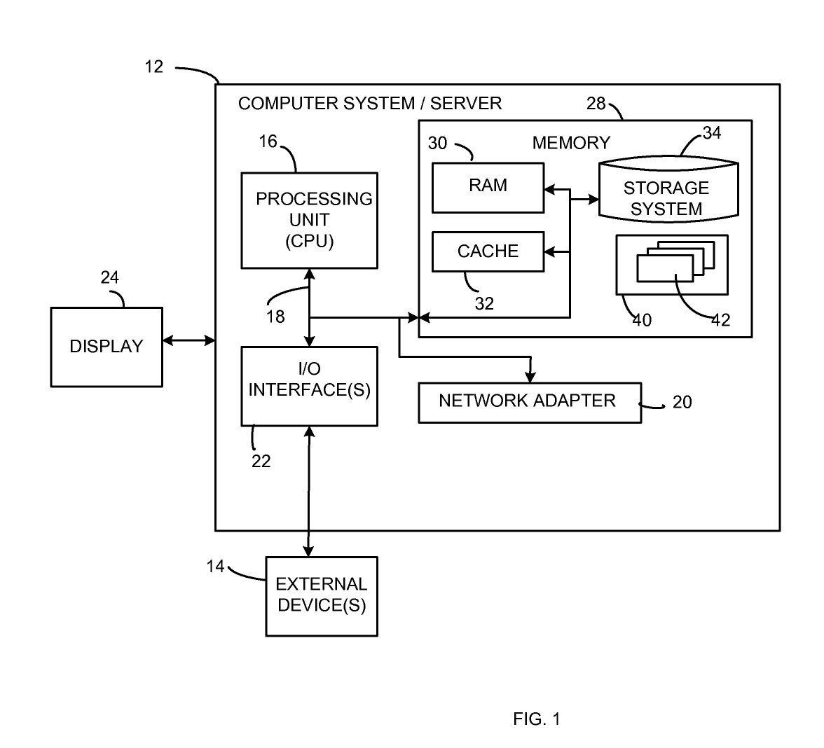

Referring now to FIG. 1, a block diagram of an exemplary computer system/server 12 which is applicable to implement the embodiments of the present invention is shown. Computer system/server 12 is only illustrative and is not intended to suggest any limitation as to the scope of use or functionality of embodiments of the invention described herein.

As shown in FIG. 1, computer system/server 12 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

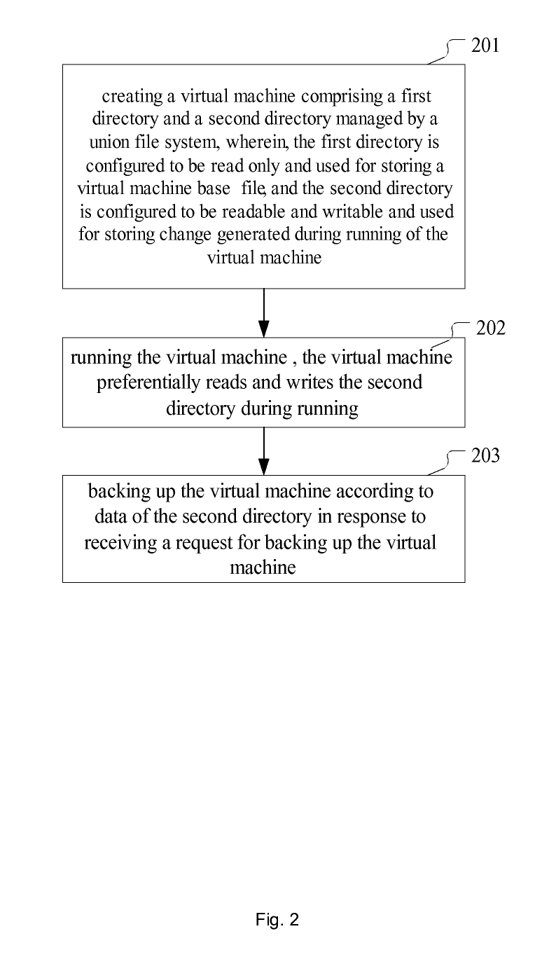

With reference now to FIG. 2, a flowchart of a backup method according to an embodiment of the present invention is shown. As shown in FIG. 2, the method at least comprises step 201, step 202 and step 203.

In step 201, a virtual machine is created comprising a first directory and a second directory. The directories are managed by a union file system. The first directory is configured to be read only and is used for storing a virtual machine base operating system file. The second directory is configured to be readable and writable and is used for storing changes generated during running of the virtual machine. In one embodiment, the generated changes include new files generated and modifications to the base operating system file during running of the virtual machine. The virtual machine base file includes the operating system on the virtual machine and other software that is pre-installed.

The union file system may merge content of directories (also referred to as branches, volumes or folders) from a plurality of file systems together so that they have a unified view, while actual physical locations of the directories may be separated. The included plurality of directories has at least one read-only (RO) directory and at least one read-write (RW) directory. Therefore, as in an embodiment of the present application, all modifications to content, attributes of a virtual machine base image file will be recorded to the second directory (RW), without affecting the base file located in the first directory (RO). The union file system has many applications, for example, merging home directories of different file systems on a plurality of disk partitions. The union file system per se performs a merge operation on file systems, instead of mounting each file system at a different place in the directory hierarchy. After being merged, files in the plurality of branches can all be accessed by the system. If the plurality of branches include more than one file by the same name, different assigned priorities differentiate which file has priority.

The union file system is, for example, UnionFS in a Linux system (Linux® is the registered trademark of Linus Torvalds in the U.S. and other countries.). The union file system establishes a folder with a same name at a mount point that is used as thoas the merged directory when the system is running. The folder under the mount point is defined to be writable and have high priority. A folder under a root directory of the file system is defined to be read only. Changes that are written to the union filesystem are recorded in the writable overlay merge directory. Thus, it can be ensued that write operations of a user are written to a directory with high priority while the system image is ensured to be read only, and meanwhile, the file redirection operation is also made to be transparent to the user.

In one embodiment, the second directory may also be set as a directory with snapshot functionality. That is, the second directory with high priority is made to be a partition with snapshot functionality when performing backup, and changes after a backup point are copied to a specified area. The Unionfs with copy-on-write functionality may merge read-only and read-write file systems together, and virtually allow modifications to the read-only file system to be stored into the writable file system. The snapshot technology therein is widely adopted in storage systems, which is initially applied to array and host, and generally processing is performed at the block level of a volume. Backup speed can be significantly improved by employing a snapshot operation, because a snapshot actually points to a reference mark or pointer pointing to data stored in a storage device. The snapshot records the state of the data at some point in time, for example, an address for reading data is indicated by establishing a list of pointers, thereby providing an image of transient data. Since there is usually no physical copy of data during snapshot creation, creation of a snapshot is almost in real-time, usually less than 1 second.

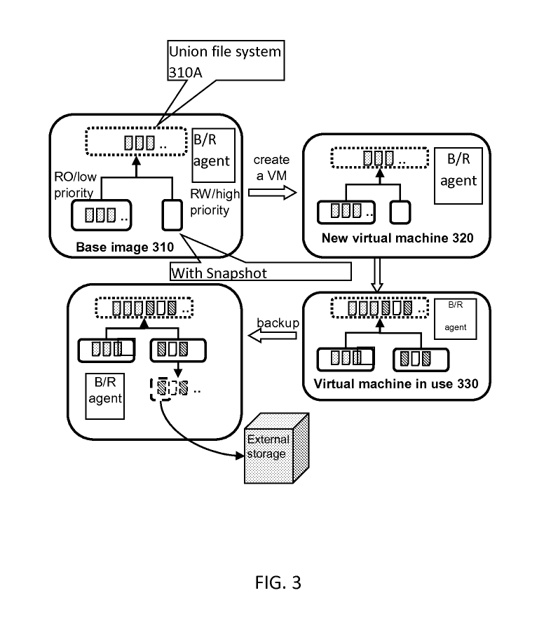

In one embodiment, the virtual machine is created according to a base image, and other software may be included in the base image based on specific need. FIG. 3 shows a process of backing up a virtual machine according to one specific embodiment of the present application. With reference to FIG. 3, a base image portion 310 (Base OS Image) may selectively comprise at least part of the following:

A union file system based file directory structure portion 310A, including: a read-only (RO) first directory with low priority which is used for storing an initial base operating system file, another read-write (RW) second directory with high priority which is used for storing future user data and future updated data of the read-only first directory. In the base image, the second directory is empty and does not have any files. Files stored into that second directory in the future during running of the system are files that should be backed up by the system.

A virtual machine activation script portion 310B (not shown in FIG. 3), corresponds to the union file system. When a user deploys a virtual machine instance by using the base image file, the activation script is responsible for extending the above second directory according to size of a virtual disk selected by the user, so that the second directory complies with requirements of the user.

A backup and restore agent portion 330, is responsible for performing data backup when the user initiates a backup request.

Therefore, in a more specific embodiment, the process of creating a virtual machine includes: determining a base image file for creating a virtual machine, and determining size of a virtual disk of the virtual machine; starting a virtual machine by a hypervisor according to the determined base image file. The image may further include therein a portion of the virtual machine disk activation script which is capable of extending the above second directory according to the disk size selected by a user during startup, so that the directory complies with the size specified by the user.

Returning to step 202 of FIG. 2, the running virtual machine preferentially reads and writes using the second directory while the virtual machine is executing.

In the process of using the virtual machine, various applications may be installed and run thereon. In this process, all newly created files and modified files in the base operating system will be stored into the second directory, and content of the second directory is content which needs to be backed up when the virtual machine is backed up. Specifically, with reference to the embodiment of FIG. 3, 330 therein is the virtual machine in use. When deployment of the new virtual machine 320 is completed, the second directory is usually the established empty volume, which is used for storing files changed based on the base image, for example, user data, custom data or other changed files. The second directory has higher priority than the first directory, and the second directory is being operated preferentially when reading and writing files in the base image. Therefore, changes caused by operation such as installation, running, writing a file etc. will all be stored into the second directory with high priority.

Then returning to step 203 of FIG. 2 the virtual machine is backed up including the data of the second directory, in response to receiving a request for backing up the virtual machine.

Now returning to FIG. 3, whether the virtual machine needs to be backed up may be determined by a backup/restore agent (B/R agent) in the virtual machine according to a received backup command. The backup command may be issued in accordance with a preset time in a backup policy, or may be issued temporarily by user through a backup management entry, for example a command line at a console. In one embodiment, the backup and restore agent may directly copy backup data, however, such copy is very time consuming and running of the virtual machine is suspended for the duration of the copy process. In another embodiment, the backup and restore agent performs the “snapshot” operation shown in FIG. 3 on the above second directory, and that process usually may be completed at millisecond level. Then the user may be notified that the backup is finished, and the user may continue to use the virtual machine.

Further, the backup operation may also include a step of writing the backup data from the snapshot to an external storage. There are various options for writing backup data from a snapshot. For example, writing of the backup data is performed based on an existing Rsync technology, which belongs to prior art and will not be described herein for brevity. When writing is completed, the backup/restore agent deletes that “snapshot”, and the entire backup operation is finished.

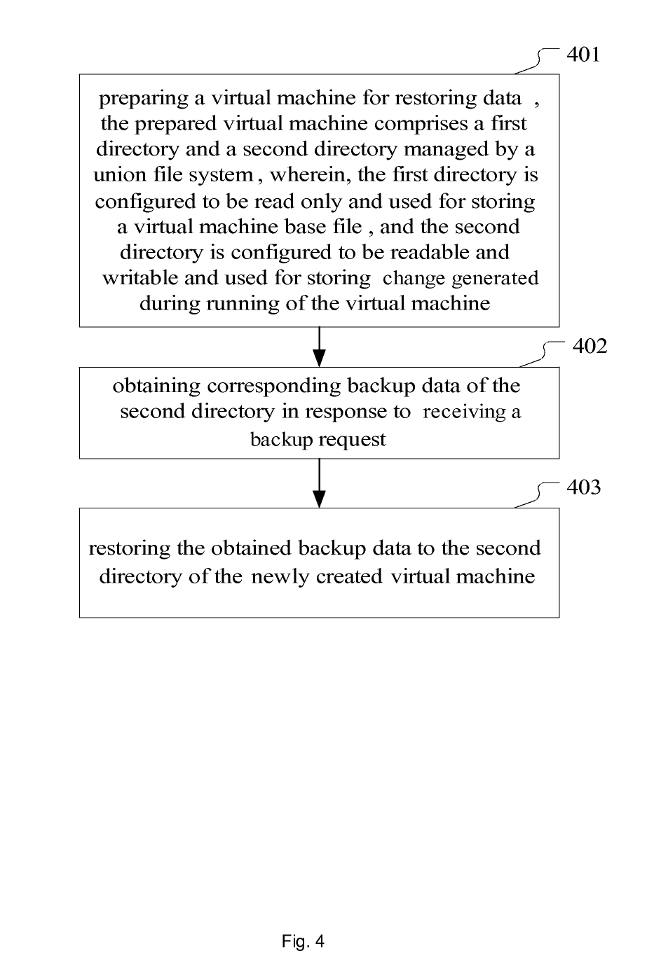

FIG. 4 shows a flowchart of a method for restoring a virtual machine according to an embodiment of the present invention.

In step 401, A virtual machine is prepared for restoring data in response to receiving a command for restoring the virtual machine. The prepared virtual machine comprises a first directory and a second directory that are both managed by a union file system. The first directory is configured to be read only and is used for storing a virtual machine base operating system file. The second directory is configured to be readable and writable and is used for storing modification to the virtual machine base operating system file during running of the virtual machine.

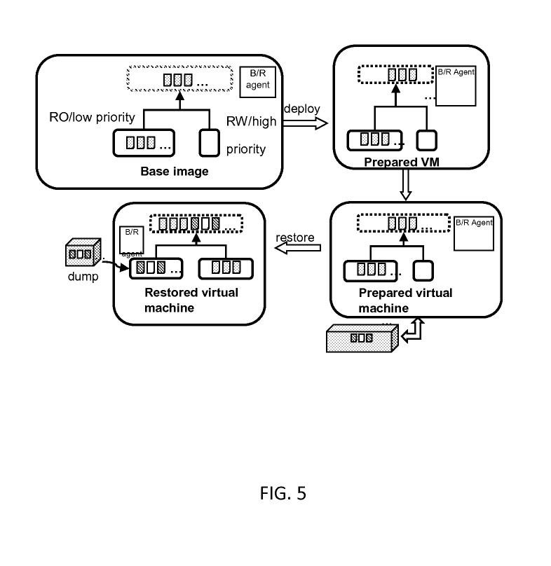

In an embodiment shown in FIG. 5, preparing a virtual machine for restoring data comprises deploying a new virtual machine according to a base image. The base operating system image may be determined according to user selection to deploy a new virtual machine, and virtual disk size of the new virtual machine is determined according to that of the old virtual machine. In another embodiment, when a virtual machine is started according to the base image file, if the base image file includes therein a portion of virtual machine disk activation script, the above second directory is extended according to disk size selected by the user in the startup process, so that the directory complies with the size specified by the user.

In another embodiment, preparing a virtual machine for restoring data comprises stopping running of the virtual machine to be restored. When this embodiment is employed, running of the virtual machine is aborted. When the virtual machine terminates, a new virtual machine is created by employing the embodiment of FIG. 5. Therefore, the restore operation of a restore agent comprises: deleting all content of the second directory of the virtual machine; writing backup data to a corresponding position according to a restore policy specified by a user.

In step 402, obtaining corresponding backup data of the second directory in response to the restore operation.

In one embodiment, a user starts the restore operation once by using a backup and restore agent of the prepared virtual machine, and specifies a position (a position in an external storage system) where the backup data is located, for example, reference may be made to an external storage system storing backup data shown in FIG. 5.

In step 403, the obtained backup data is restored to the second directory of the prepared virtual machine.

The backup data is written to the second directory by a backup/restore agent of the prepared virtual machine. Specifically, with reference to the embodiment of FIG. 5, when external backup data is written to the second directory, a unified view of the virtual machine merged by the union file system just includes that backup data, thereby restoration of the virtual machine is realized. The user is notified that restoration of the virtual machine is finished when the dump is completed.

When preparation is performed by stopping the virtual machine to be restored, the restore operation of the restore agent comprises: deleting all content of the second directory of the virtual machine; writing the backup data to a corresponding position according to a restore policy specified by the user.

The above description is given based on virtual machine of a Linux operating system. For virtual machine of a Windows operating system, the two technologies also have their implementations. For example, Winunionfs is an implementation of a union file system in the Windows® operating system, and VSS (Volume Shadow copy Service) is an implementation of snapshot technology of the Windows® system. Thus, the present application may be applicable to both virtual machines of Linux® and Windows® operating system and possess generality.

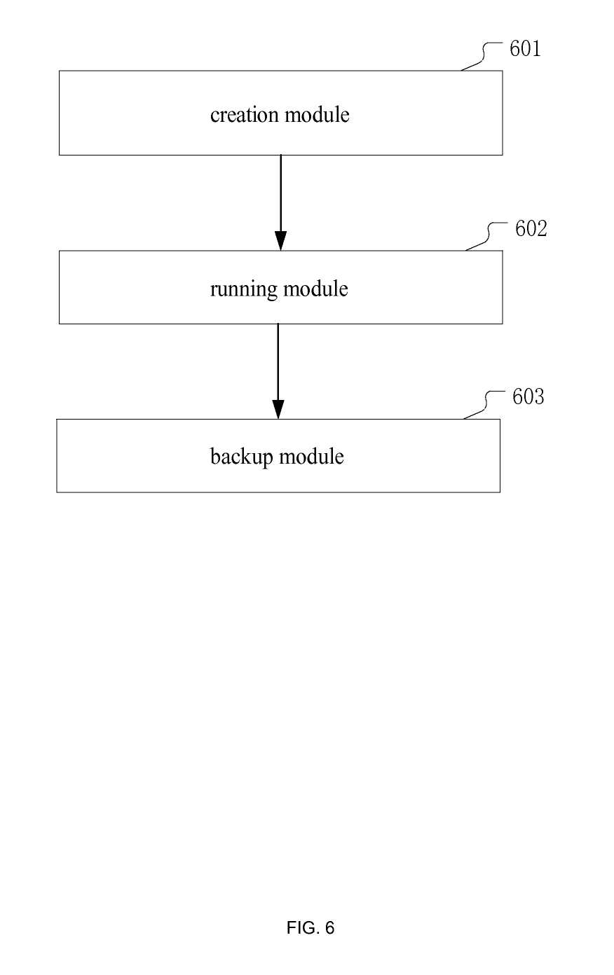

FIG. 6 shows a diagram of a device for backing up a virtual machine according to an embodiment of the present invention.

A creation module 601 is configured to create a virtual machine that includes a first directory and a second directory, both of which are managed by a union file system. The first directory is configured to be read only and is used for storing a virtual machine base operating system file. The second directory is configured to be readable and writable and is used for storing modification to the base operating system file during running of the virtual machine. A running module 602 is configured to run the virtual machine which preferentially reads and writes the second directory during running. A backup module 603 is configured to back up the virtual machine according to data of the second directory in response to receiving a request for backing up the virtual machine.

In one embodiment, creating a virtual machine includes creating the virtual machine according to a base image file. The base image file includes a first directory and a second directory, both of which are managed by a union file system.

In one embodiment, the second directory is an empty directory configured to be readable and writable.

In one embodiment, the second directory is a snapshot operation enabled volume.

Backing up the virtual machine according to data of the second directory includes performing snapshot operation on the data of the second directory.

In one embodiment, the backup operation is performed by a backup/restore agent, which is located in the virtual machine and which manages the virtual machine where the backup/restore agent is located.

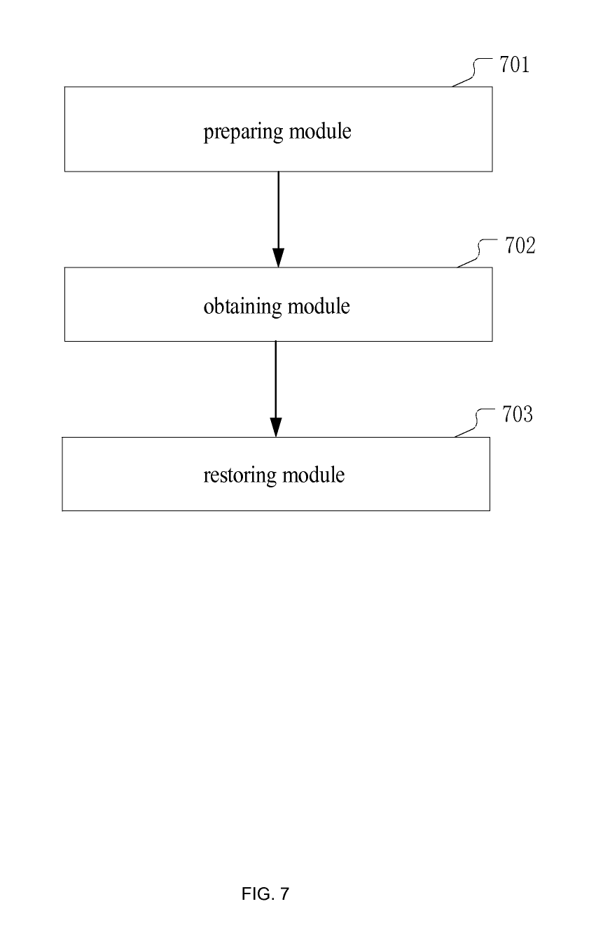

FIG. 7 shows a diagram of a device for restoring a virtual machine according to an embodiment of the present invention. The device includes a preparing module 701 configured to prepare a virtual machine for restoring data. The prepared virtual machine includes a first directory and a second directory, both of which are managed by a union file system. The first directory is configured to be read only and is used for storing a virtual machine base operating system file, and the second directory is configured to be readable and writable and is used for storing modification to the base image during running of the virtual machine. An obtaining module 702 is configured to obtain corresponding backup data of the second directory in response to receiving a restore request. A restoring module 703 is configured to restore the obtained backup data to the second directory of the newly created virtual machine.

In one embodiment, preparing a virtual machine for restoring data includes creating the virtual machine according to a base image. The base image comprises a first directory and a second directory, both of which are managed by a union file system.

In one embodiment, the prepared virtual machine further includes a backup/restore agent. The obtained backup data is restored to the second directory of the newly created virtual machine by the backup/restore agent.

In one embodiment, the restoring operation of the restore agent includes deleting content of the second directory on the virtual machine and writing the backup data to a corresponding position, such as in an external storage system, according to a restore policy specified by a user.

Thus, with the backup technology of the present application, there is no need to be aware of the technology of an underlying hypervisor, nor cooperation of a hypervisor is needed. VM level backup can be realized as long as a VM with foregoing features is deployed, it is a VM backup/restore technology independent of IaaS and hypervisor.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for backing up a virtual machine, comprising:
creating a virtual machine comprising a first directory and a second directory managed by a union file system, wherein, the first directory is configured to be read only and used for storing a virtual machine base operating system file, and the second directory is configured to be readable and writable and used for storing changes generated during running of the virtual machine;
running the virtual machine, the virtual machine preferentially reads and writes the second directory during running; and
backing up the virtual machine according to data of the second directory in response to receiving a request for backing up the virtual machine.

2. The method of claim 1, wherein creating a virtual machine further comprises: creating the virtual machine according to a base image file.

3. The method of claim 1, wherein, in the created virtual machine, the second directory is an empty directory.

4. The method of claim 1, wherein the second directory is a snapshot operation enabled directory, and wherein the step of backing up the virtual machine according to data of the second directory comprises: performing snapshot operation on the data of the second directory.

5. The method of claim 1, wherein the virtual machine further comprises a backup/restore agent, and backing up the virtual machine according to data of the second directory in response to receiving a request for backing up the virtual machine is performed by the backup/restore agent.

6. A method for restoring a virtual machine, comprising:
preparing a virtual machine for restoring data, wherein the prepared virtual machine comprises a first directory and a second directory managed by a union file system, wherein, the first directory is configured to be read only and used for storing a virtual machine base operating system file, and the second directory is configured to be readable and writable and used for storing change generated during running of the virtual machine;
obtaining corresponding backup data of the second directory in response to receiving a restore request; and
restoring the obtained backup data to the second directory of the prepared virtual machine.

7. The method of claim 6, wherein the step of preparing a virtual machine for restoring data further comprises: creating a new virtual machine according to a base image.

8. The method of claim 6, wherein the prepared virtual machine further comprises a backup/restore agent, and the obtained backup data is restored to the second directory of the newly created virtual machine by the backup/restore agent.

9. The method of claim 6, further comprising:
deleting, by the backup/restore agent, a content of the second directory on the virtual machine; and
writing, by the backup/restore agent, the backup data to a corresponding position according to a restore policy specified by a user.

10. A device for backing up a virtual machine, comprising:
a creation module configured to create a virtual machine comprising a first directory and a second directory managed by a union file system, wherein the first directory is configured to be read only and used for storing a virtual machine base operating system file, and the second directory is configured to be readable and writable and used for storing change generated during running of the virtual machine;
a running module configured to run the virtual machine, the virtual machine preferentially reads and writes the second directory during running; and
a backup module configured to back up the virtual machine according to data of the second directory in response to receiving a request for backing up the virtual machine.

11. The device of claim 10, wherein creating a virtual machine comprises creating the virtual machine according to a base image file, the base image file comprises a first directory and a second directory managed by a union file system.

12. The device of claim 10, wherein the second directory is an empty directory configured to be readable and writable.

13. The device of claim 10, wherein the second directory is a snapshot operation enabled volume, wherein backing up the virtual machine according to data of the second directory comprises: performing snapshot operation on the data of the second directory.

14. The device of claim 10, wherein, the backup operation is performed by a backup/restore agent, the backup/restore agent is located in the virtual machine and manages the virtual machine where the backup/restore agent is located.

15. A device for restoring a virtual machine, the device comprising:
a preparing module configured to prepare a virtual machine for restoring data, wherein the prepared virtual machine comprises a first directory and a second directory managed by a union file system, wherein, the first directory is configured to be read only and used for storing a virtual machine base operating system file, and the second directory is configured to be readable and writable and used for storing changes generated during running of the virtual machine;
an obtaining module configured to obtain corresponding backup data of the second directory in response to receiving a restore request; and
a restoring module configured to restore the obtained backup data to the second directory of the newly created virtual machine.

16. The device of claim 15, wherein preparing a virtual machine for restoring data comprises:
creating the virtual machine according to a base image.

17. The device of claim 15, wherein the prepared virtual machine further comprises a backup/restore agent, and the obtained backup data is restored to the second directory of the newly created virtual machine by the backup/restore agent.

18. The device of claim 15, further comprising:
deleting, by the restore agent, a content of the second directory on the virtual machine; and
writing, by the restore agent, the backup data to a corresponding position according to a restore policy specified by a user.
